(19) United States
(12) Patent Application Publication
(10) Pub. No.: US 2011/0290194 A1
(43) Pub. Date: Dec. 1, 2011

(54) CURVED PEN FOR HORSES

(76) Inventor: Curtis D. GARDNER, Fort Worth, TX (US)

(21) Appl. No.: 13/117,349

(22) Filed: May 27, 2011

Related U.S. Application Data
(60) Provisional application No. 61/350,194, filed on Jun. 1, 2010.

(51) Int. Cl. A01K 3/00; E04H 17/18

(52) U.S. Cl. 119/502; 256/25

(57) ABSTRACT

A safe circular horse pen which is easily assembled and disassembled. The pen is constructed of multiple panels arranged end-to-end. Each panel includes a vertical pole with an L-shaped leg and six horizontal bars secured to the vertical pole at vertically spaced apart intervals. The unattached ends of the poles are hollow and each unattached end couples to the next adjacent panel by receiving a loop extending from the side of the pole of the next adjacent panel such that a bolt may be passed through a vertical opening in the unattached end to lock each horizontal arm to the pole of the next adjacent panel. The individual panels may be nested in pairs for storage and shipping.

### CROSS REFERENCE TO RELATED APPLICATIONS

The present application claims priority under 35 USC §119 to provisional application 61/350,194 filed Jun. 1, 2010, which is incorporated herein by reference.

### BACKGROUND

This invention pertains to circular or curved enclosing horse pens.

Pens and fences have been used to corral livestock for centuries. In modern times, circular pens have been constructed of a series of fence panels having vertical posts on each end which are interconnected by fixed horizontal bars. The panels are connected end-to-end with chains or wire to form the pen. Such construction necessarily creates a pair of adjacent vertical posts at each panel connection and therefore provides a potential slot between the posts into which a hoof may become caught. The use of fence panels requires multiple chains or wire to make each end-to-end connection and involves considerable labor in set up and take down.

In U.S. Pat. No. 6,840,194, a round pen is constructed of a series of vertical posts having openings for solid horizontal bars between adjacent posts and loops along the length of the posts to receive flexible cables which extend around all vertical posts of the pen. The pen of U.S. Pat. No. 6,840,194 is substantially permanent in that the vertical posts must be inserted into the ground to hold them upright during assembly of the pen.

An easy to assemble curved pen which reduces risks of injury to penned horses is needed.

### SUMMARY OF THE INVENTION

The present invention provides a circular or round pen for horses which features a series of interconnecting panels which each have a single vertical pole with permanently attached horizontal bars extending from the pole. Each pole includes multiple loops or tabs along the pole, each loop or tab having an opening therethrough. Each loop or tab extends a short distance from the pole on the opposite side of the pole from the horizontal bars and is aligned with one of the horizontal bars.

The free end of each horizontal bar includes a cavity into which the loop or tab of the vertical pole of an adjacent panel is inserted. A locking pin or bolt is passed through a vertical opening in the horizontal bar above and below the opening of the loop or tab, thereby connecting each horizontal bar to the vertical pole of the next adjacent panel. The construction results in a single vertical pole at the connections of adjacent panels so that no entrapments for animal hooves are present in the completed pen.

The free ends of the horizontal bars are shaped to conform to the circumference of the pole members so that the loop inserted into each cavity is surrounded by the horizontal bar and hidden within it. Optionally, horizontal slots may be cut in opposing sides of the free ends of the horizontal bars alongside the receiving cavities to allow for additional variability in the angle made between a first panel and a panel adjacent to it.

It is a primary objective of this invention to provide a lightweight circular pen that is strong, sturdy, easy to move and easy to assemble. It is a further objective of the invention to provide a circular pen which is free of gaps into which horses may become entrapped. It is still a further objective of the invention to provide a round pen that has hidden connectors between panels.

### BRIEF DESCRIPTION OF THE DRAWINGS

FIG. 1 is a perspective view of the preferred embodiment curved pen in a circular configuration.

FIG. 2 is a perspective view of the pen of FIG. 1 with the gate panel open.

FIG. 3 is a perspective view of the standard pen panel of the invention.

FIG. 4 is a close up exploded top view of the vertical post end of the panel of FIG. 3 and an adjoining panel ready to be coupled to the vertical post.

FIG. 5 is an enlarged perspective of the interconnection of a top horizontal bar of an adjoining panel to the vertical pole of a first panel.

FIG. 6 is a perspective view of the gate panel seen in FIGS. 1 and 2 linked to an upright hinge pole.

FIG. 7 illustrates a nesting of first and second standard pen panels for shipment.

### DETAILED DESCRIPTION

Throughout this specification, identical parts of the structure are referenced identically except multiples of the same element have been sometimes referenced by the indicator ′ beside the reference numeral.

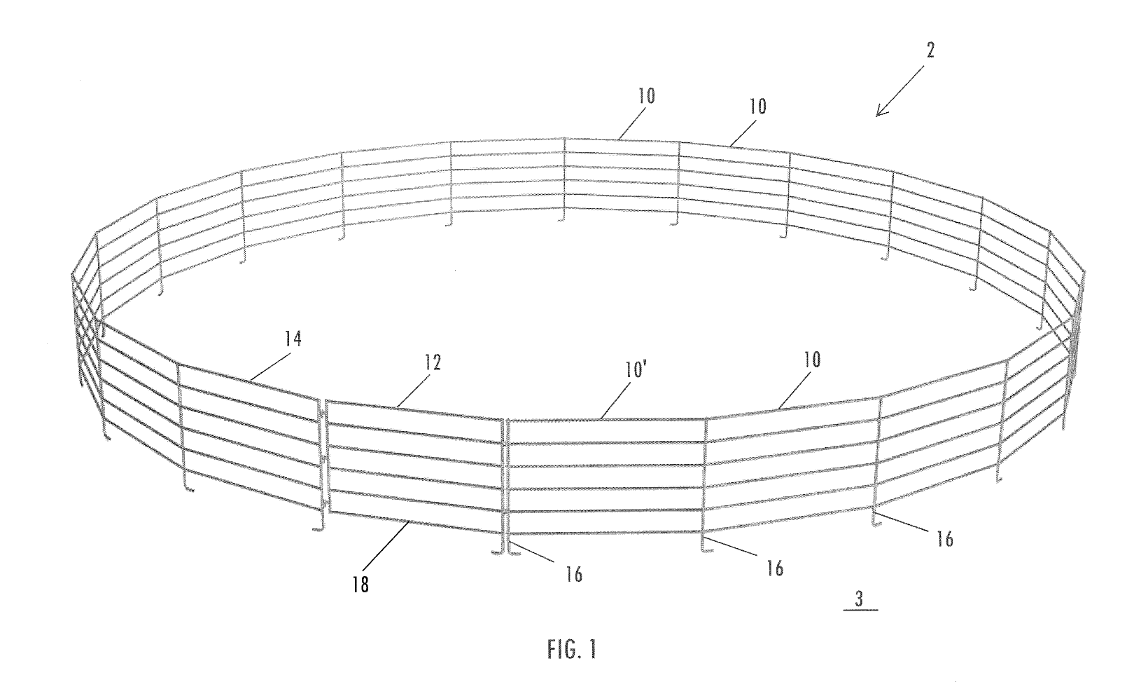

FIG. 1 illustrates a circular pen 2 according to the present invention with no openings in the pen 2, the pen panels 10 creating an endless loop in cooperation with gate panel assembly 18 which includes gate panel 12. Panels 10 and 12 are of generally equal height, preferably about six feet, to make the pen 2 suitable for horses. Panels 10, 12 are also of generally the same eight foot length, allowing twenty panels to make about a fifty foot diameter circular pen 2. It can be seen that legs 16, 17 of panels 10, 12, are generally L-shaped and rest on the ground surface 3.

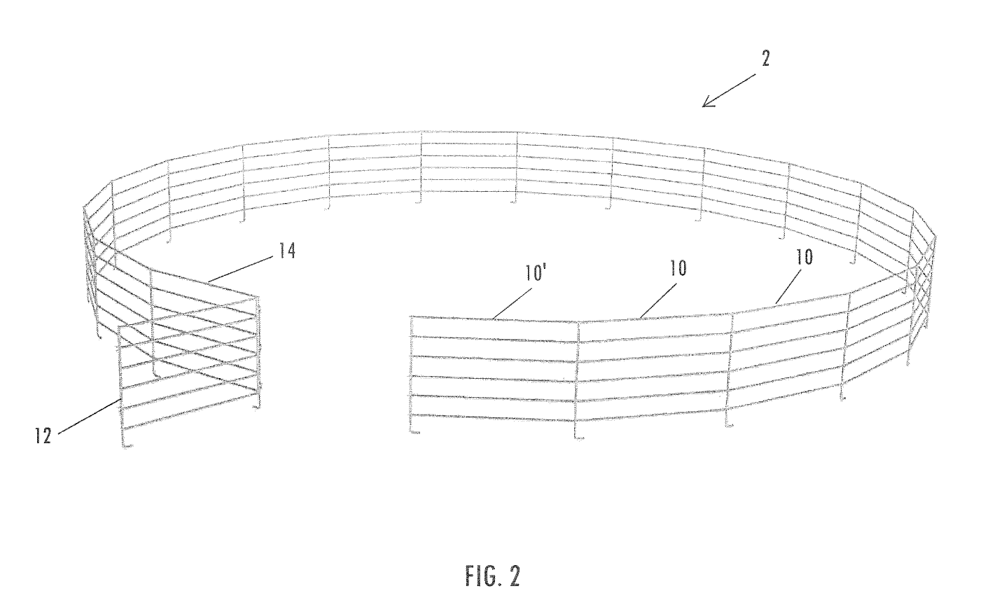

FIG. 2 discloses the pen 2 with gate panel 12 open, that is with gate panel 12 rotated about hinge pole 80 and separated from formerly adjacent panel 10′. Panel 10′ is identical to each other panel 10 but has been denominated 16 to distinguish it from other panels 10 which are not adjacent to gate panel 12 when gate panel 12 is moved to the closed position.

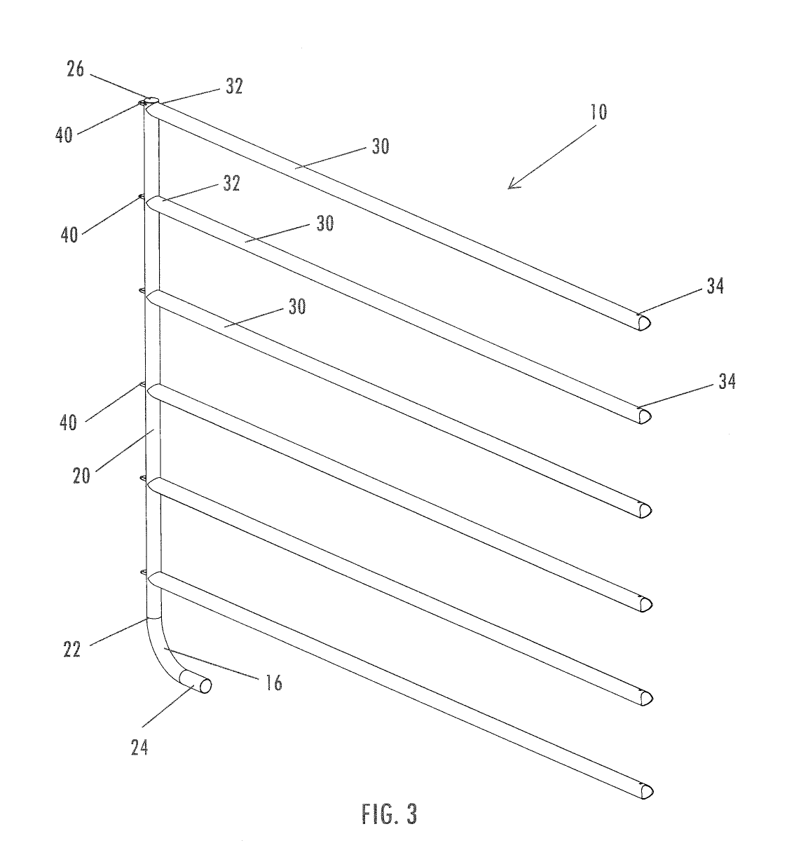

Referring now to FIG. 3, a standard panel 10 is illustrated and can be seen to comprise an upstanding post or pole 20 having leg 16 joined thereto at its lower end 22. Vertical pole 20 is topped by cap 26. Leg 16 is preferably integral with pole 20 and is curved to an L-shaped configuration such that lateral 24 of leg 16 is perpendicular to the longitudinal axis of pole 20. Pole 20 and leg 16 are preferably formed of hollow 16 gauge galvanized pipe of approximately 1.75 inch diameter.

Joined securely to vertical pole 20, preferably by welding, are six horizontal bars 30 which join vertical pole 20 at first ends 32 thereof and extend in a first direction from pole 20. Each horizontal bar 30 terminates in free end 34 which opposes first end 32 thereof. It can be observed that each horizontal bar 30 is hollow at free end 34. Preferably each horizontal bar 30 is constructed of galvanized 16 gauge pipe of 1.75 inch diameter.

Aligned with the longitudinal axis of each horizontal bar 30 is a retaining element 40 fixed to vertical pole 20 and extending a short length therefrom, preferably about one to two inches. Retaining elements 40 are horizontally aligned with the centerline of the horizontal bars 30 but extend in a substantially opposing direction.

Generally, the effective height of pole 20 is six feet and each horizontal bar 30 is spaced along vertical pole 20 at one foot intervals. The nominal length of panel 10 is eight feet.

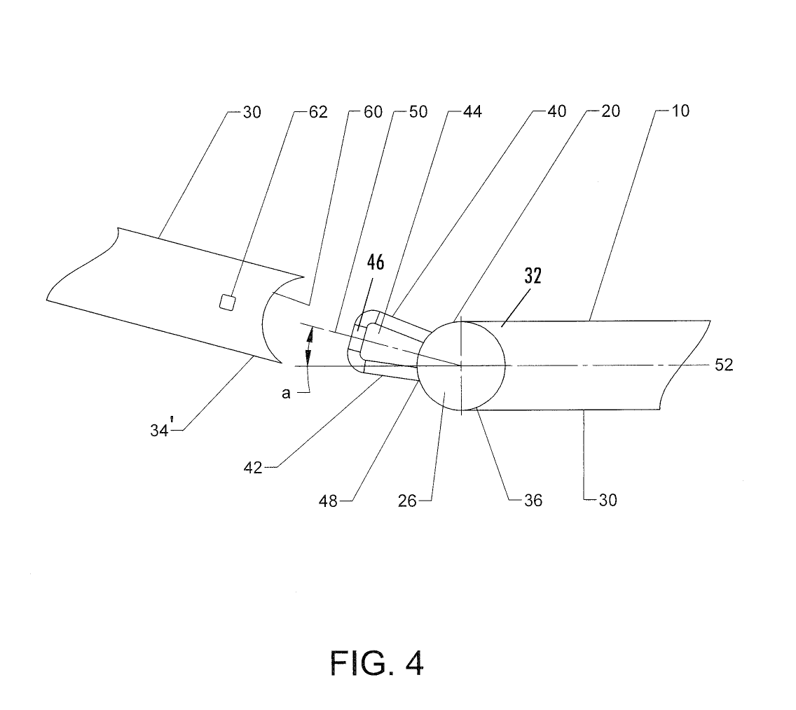

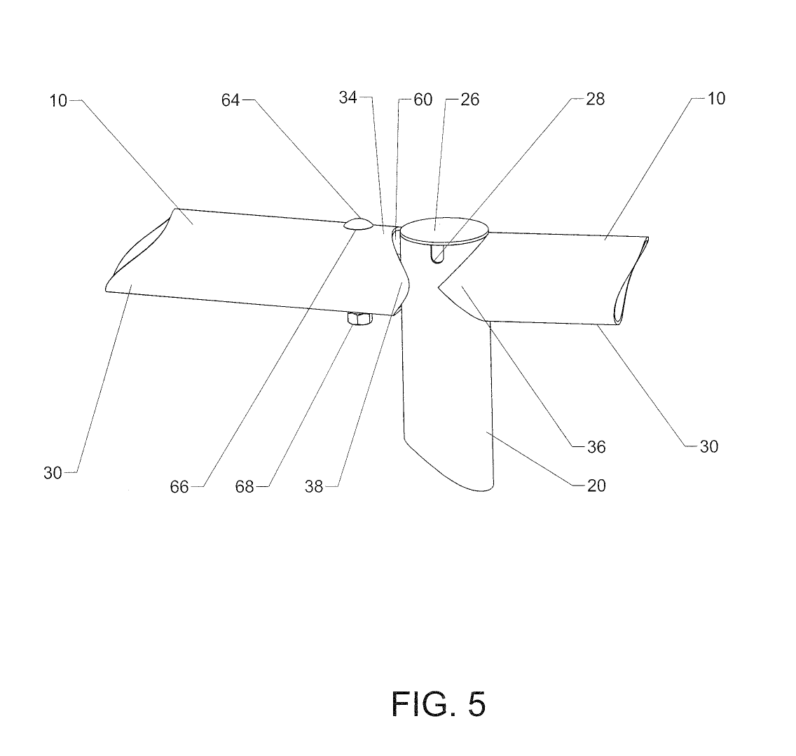

Referring now additionally to FIGS. 4 and 5, details of the invention may be better observed. FIG. 4 shows an enlargement of a segment of panel 10 wherein it can be seen that each horizontal bar 30 is welded to vertical pole 20 by a coping or saddle 36, the end 32 of horizontal bar 30 being cut away to conform to the curved sidewall of vertical pipe 20.

Extending from vertical pole 20 opposingly to horizontal bar 30 is retaining element 40 which is welded or otherwise fixed securely to vertical pole 20. Retaining element 40 preferably comprises a generally U-shaped loop 42 defining an opening 44 which is wider at the distal end 46 of loop 42 than at its proximal end 48. Opening 44 is enlarged near distal end 46 to allow some variation in the location of a locking pin or bolt passing through opening 44.

The centerline 50 of retaining element 40 is at angle a from an extension of the longitudinal axis 52 of horizontal bar 30. Angle a is preferably 10-25° and more preferably about 18°. Therefore the centerline 50 of each retaining element 40 is approximately 150 to 170 degrees separated from the direction of extension of each horizontal bar 30 from vertical pole 20, that is, retaining elements 40 extend 150 to 170 degrees from the direction of the extension of horizontal bars 30 from vertical pole 20. This orientation of retaining element 40 in relationship to the longitudinal axis 52 of horizontal bar 30 permits each panel 10 to join an immediately adjoining panel 10 to form a curved enclosure. When angle a is nominally 18°, a pen comprising 20 equal length panels 10 can be formed. However, with the variability of angle between one panel 10 and the next identical panel 10 provided by the outwardly tapered opening 44, the panels 10 can be joined to provide differing diameters of pen 2. Excess space in tapered opening 44 for bolt 64 allows the angle between neighboring panels 10 to vary from about 180 degrees to about 144 degrees. The width of tapered opening 44 at distal end 46 therefore allows one panel 10 to alternatively be longitudinally aligned with the adjacent panel 10 when a straight length of fence is desired.

FIG. 4 also discloses horizontal bar 30 of an adjacent panel 10. Free end 34 is hollow (each horizontal bar 30 may be a hollow pipe) creating a cavity 60 for receiving retaining element 40. A vertical opening 62 transversely passes through horizontal bar 30 such that a bolt entering opening 62 will pass through opening 44 of loop 42 when retaining element 40 is substantially fully inserted into cavity 60.

In FIG. 5, the attachment of a first panel 10 to an adjoining panel 10′ is shown in an enlargement of the top of pole 20. It is seen that horizontal bar 30 (the top most) is secured, preferably by welding, to vertical pole 20 including at saddle 36. Adjoining panel 10′ is removably fastened to first panel 10 by the horizontal bars 36 thereof. The free end 34′ of horizontal bar 30′ is formed with a cope 38 which wraps around the vertical pole 20. The uppermost retaining element 40 of pole 20 is not visible in FIG. 5 because it has been inserted into the cavity 60 at free end 34′ of horizontal bar 30′. A bolt 64 having an enlarged head 66 which will not pass through opening 62 (see FIG. 4) is in place, being locked in position by nut 68. Cap 26 tops pole 20 while vent notch 28 is left open to the interior of pole 20.

FIGS. 4 and 5 make clear that variability in the angle between one panel 10 and the next can occur because the width of opening 44 of retaining element 40 is much larger than the diameter of a bolt 64 passing through it, thereby allowing differences in the diameter of pen 2.

It should be noted that slots may optionally be formed in free ends 34 to permit greater variability of angular relationship between adjacent panels 10.

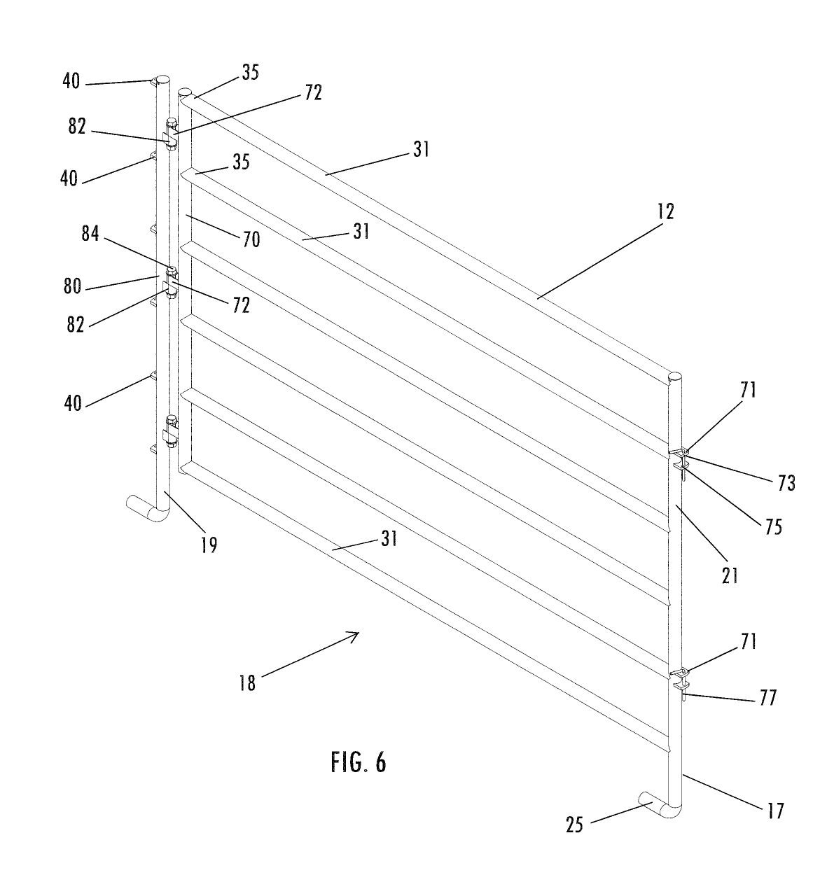

Referring back to FIG. 2, it can be seen that gate panel 12 has been detached from first panel 10′ and swung outward around hinge pole 80 of gate assembly 81. FIG. 6 shows details of gate assembly 18.

Gate assembly 18 includes gate panel 12 and hinge pole 80. Gate panel 12 is constructed very similarly to panels 10 except that a second pole 70 interconnects the distal ends 35 of horizontal bars 31 and is welded or otherwise permanently secured to horizontal bars 31. Horizontal bars 31 are welded to first vertical pole 21 at approximately one foot spacings, beginning about one foot above the lateral segment 25 of leg 17. Except for being part of first vertical pole 21, leg 17 is identical to leg 16 of standard panel 10.

As can be seen in FIG. 6, first vertical pole 21 includes latch elements 71 which are in alignment with two of horizontal bars 31. Latch elements 71 comprise upper and lower tabs 73, 75 which will align with two of the retaining elements 40 of a standard panel 10 such that latch pins 78 can be dropped through upper tab 73 through opening 44 of a retaining element 40 and then through lower tab 75 making a selectively latched connection with the pole 20 of an adjacent panel 10.

Second vertical pole 70 includes first hinge elements 72 which cooperate with complementary second hinge elements 82 of hinge pole 80. Hinge pole 80 includes multiple retaining elements 40 which are identical to retaining elements 40 of standard panels 10. The retaining elements 40 of hinge pole 80 couple to the free ends 34 of horizontal bars 30 of a standard panel 10 as illustrated in FIG. 4 and described in reference thereto. As with retaining elements 40 of standard panels 10, each retaining element 40 is located along hinge pole 80 so that it will align with the free end 34 of a horizontal bar 30 of the next adjoining panel 10. Hinge pole 80 includes a leg 19 analogous to legs 16, 17. Therefore, to provide a gate assembly 18, a hinge pole 80 is attached to a standard panel 10. Then a gate panel 12 is hinged to hinge pole 80 by aligning hinge panel elements 72, 82 and inserting hinge pins 84 therethrough.

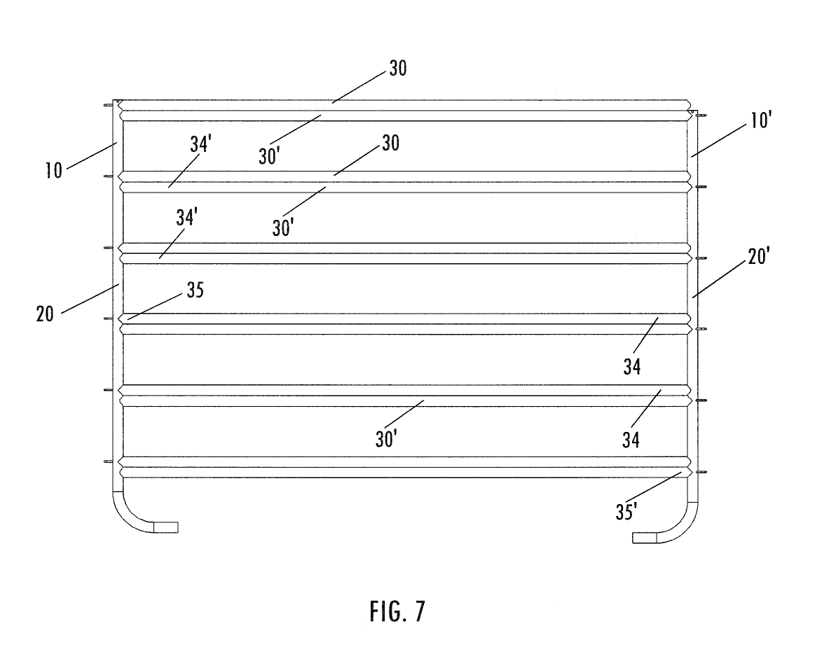

FIG. 7 shows two standard panels 10, 10 nested for shipment or storage. The first panel 10 may be laid on a pallet with horizontal bars 30 thereof extending toward a first side, namely the right-hand side as shown in FIG. 7, with the second panel 10′ laid beside and slightly offset from first panel 10 such that the horizontal bars 36 of second panel 10′ lie alongside but in opposite orientation to the horizontal bars 30 of first panel 10. The free ends 34 of the horizontal bars 30 of first panel 10 will abut the vertical pole 20′ of the second panel 10′. Likewise, the free ends 34′ of horizontal bars 30′ of second panel 10′ will abut the vertical pole 20 of the first panel 10. By nesting pairs of panels 10, reduced space is needed to store or ship the pen 2 components.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

What is claimed is:

1. A curved horse pen comprising
a series of panels joined end to end,
each panel comprising an elongate upright member at a first end of the panel and a series of elongate horizontal bars extending from the elongate upright member in a first direction,
each horizontal bar having a free end with a receiving cavity therein,
the free end of each horizontal bar including a transverse passageway therethrough communicative with the cavity of the free end,
the upright member further comprising a plurality of retaining elements spaced therealong,
each retaining element substantially horizontally aligned with an individual one of the horizontal bars of the panel,
each retaining element extending a short distance from the upright member in a second direction generally diametrically opposed to the first direction,
each retaining element of the upright member of a first panel received in the receiving cavity of the free end of a one of the horizontal bars of an adjacent panel,
a pin selectively insertable through the passageway of the free end of each horizontal bar of the first panel and through the retaining element of the upright member of the adjacent panel thereby retaining each horizontal bar of the first panel to the upright member of the adjacent panel.

2. The horse pen of claim 1 wherein
each horizontal bar is irremovably secured at a first end thereof to the elongate upright member,
the first end of each horizontal bar opposing the free end of the horizontal bar,
each horizontal bar at each end thereof including a saddle,
the saddle of the first end of each bar secured to the upright elongate member.

3. The horse pen of claim 1 wherein
the upright member of each panel is a hollow galvanized pipe.

4. The horse pen of claim 3 wherein
each horizontal bar is a hollow galvanized pipe,
the first end of each horizontal bar is welded to the upright member.

5. The horse pen of claim 1 wherein
each upright member includes a leg at a lower end thereof,
each leg includes a lateral segment which supports the panel upon a ground surface.

6. A panel for an endless livestock pen comprising
a vertical pole at a first end of the panel,
a plurality of horizontal hollow pipes extending from the pole, the horizontal pipes spaced apart generally equidistantly along the pole,
each horizontal pipe secured to the vertical pole,
each horizontal pipe extending toward a second end of the panel,
each horizontal pipe having a free end at the second end of the panel,
a plurality of short loop elements fixed along the pole and extending a short distance therefrom,
each loop element extending in a direction generally away from the second end of the panel,
each loop element laterally aligned with a one of the horizontal pipes,
each loop element including an opening therethrough,
a vertical opening through a top and bottom of each horizontal pipe a short distance from the free end of the horizontal pipe,
a pin element selectively insertable through the vertical opening of the free end of each horizontal pipe to selectively lock the horizontal pipe to an aligned loop element on the vertical pole of an adjacent panel.

7. The panel of claim 6 wherein
each free end is concave and conforms generally to an outer wall of the vertical pole.

8. The panel of claim 6 wherein
each of the loop elements extends at between approximately 155° and 170° from a longitudinal axis of the horizontal bar.

9. An endless curved livestock pen comprising
a series of panels joined end to end,
each panel comprising:
an elongate generally vertical member,
a plurality of generally parallel, spaced apart elongate horizontal members,
each horizontal member having a fixed end and a free end opposing the fixed end thereof,
each horizontal member irremovably secured at the fixed end thereof to the elongate vertical member,
each horizontal member extending from the vertical member in a first direction,
the vertical member including a plurality of short retaining elements extending therefrom in a second direction generally opposing the first direction,
each horizontal member having a cavity therein at the free end thereof,
a transverse passageway through the free end of each horizontal member,
the passageway communicative with the cavity of horizontal member,
a lock element selectively insertable within the passageway.

10. The livestock pen of claim 9 wherein
the vertical member of each panel includes a leg at a lower end thereof,
the leg including a lateral segment,
the lateral segment supporting the vertical member upon a ground surface.

11. The livestock pen of claim 10 wherein
the leg is integral with the vertical member.

12. The livestock pen of claim 9 wherein
the vertical member of each panel is a hollow cylindrical pipe,
each horizontal member of each panel is a hollow cylindrical pipe,
each horizontal member welded to the vertical member.

13. The livestock pen of claim 9 wherein
each retaining element of the vertical member of each panel horizontally aligned with an individual one of the horizontal members,
each retaining element extending from the vertical member at approximately 18 degrees from a longitudinal axis of the horizontal member aligned therewith,
the passageway through the free ends of each horizontal member is substantially vertical.

14. The livestock pen of claim 9 wherein
the vertical member of each panel is a hollow cylindrical galvanized pipe,
each horizontal member is a hollow cylindrical galvanized pipe,
each horizontal member including a saddle at the free end thereof,
the coping of each horizontal member welded to the vertical member,
the vertical member includes am integral leg at a lower end thereof,
the leg including a lateral segment,
the lateral segment supporting the vertical member upon a ground surface,
each retaining element is a loop,
each loop horizontally aligned with an individual one of the horizontal members,
each loop extending from the vertical member at extends from the vertical member at approximately 18 degrees from a longitudinal axis of the horizontal member aligned therewith,
the passageway through the free ends of each horizontal member is substantially vertical,
the lock element is a bolt with an enlarged head,
whereby each loop of a first panel may be received in the cavity of the free end of a one of the horizontal members of an adjoining panel, and the bolt may be inserted through the loop when the bolt is inserted into the vertical passageway of the free end of the horizontal member.
